(19) United States
(12) Patent Application Publication
(10) Pub. No.: US 2026/0322505 A1
(43) Pub. Date: Oct. 15, 2026

(54) SYSTEMS FOR AN ACOUSTIC WAVE TRANSMISSION BETWEEN DIFFERENT MEDIA USING A PLATE

(71) Applicant: Toyota Motor Engineering & Manufacturing North America, Inc., Plano, TX (US)

(72) Inventor: Taehwa Lee, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/174,113

(22) Filed: Apr. 9, 2025

(51) Int. Cl. H04B 11/00

(52) U.S. Cl. CPC H04B 11/00

(57) ABSTRACT

Systems and other embodiments described herein relate to increasing a transmission power of an acoustic wave traversing between an air and water interface through a plate. In one embodiment, a system includes a plate having subplates that are positioned between a first medium and a second medium. The system also includes the plate that receives an acoustic wave that propagates from the first to the second medium. The system also includes the subplates that are perforated with circular holes at centers, the subplates having a first depth and the acoustic wave propagates through the circular holes. The system also includes cavities of the subplates having a second depth that is less than the first depth. The system also includes the circular holes and the cavities that propagate the acoustic wave at a resonant frequency, and a transmission frequency of the acoustic wave is associated with the resonant frequency.

### TECHNICAL FIELD

The subject matter described herein relates, in general to an acoustic wave transmitting between different media, and, more particularly, to the acoustic wave traversing between an air and water interface through a plate that increases transmission power.

### BACKGROUND

Acoustic waves traveling between different media can encounter physical changes. Density differences and the sound speed varying can cause these physical changes. For instance, air has a different acoustic impedance than water which impacts wave speed and wavelength. As an acoustic wave enters water, speed can increase due to the higher density. The speed increase causes a wavelength increase. Additionally, wave directionality can alter due to refraction. An incidence angle and refraction are related to the wave speeds for the various media types.

In various implementations, systems transmitting and receiving acoustic waves encounter technical issues. For example, an acoustic wave reflecting upon impacting a new medium reduces energy that enters the new medium. This reflection occurs because of the impedance mismatch between different media (e.g., air and water). Refraction can also distort a path of an acoustic wave that impacts the accuracy for the systems (e.g., an information system). Attenuation and energy loss can reduce the range of the acoustic wave between a transmitter and receiver. Thus, the aforementioned factors can complicate the transmission of sound waves across an interface having different media and hinder various applications.

### SUMMARY

In one embodiment, example systems and embodiments relate to increasing a transmission power of an acoustic wave traversing between an air and water interface through a plate that is perforated. In various implementations, systems relying upon underwater acoustics (e.g., sonar technology) encounter difficulties from reflection, refraction, and distortions of an acoustic wave crossing an air-water interface. For instance, a resonator sending an acoustic wave from an underwater transmitter (e.g., submarine) incorrectly detects an acoustic wave because of reflection losses reducing power caused varying material densities between media. Such losses may be encountered at the air-water interface from impedance differences between different media. Structures reducing the reflection losses on the resonator increase costs and complications. In another example, an underwater vehicle fails to pick-up safety data transmitted from an information system using an acoustic wave from misalignment. Here, the misalignment may be associated the acoustic wave encountering refraction when crossing from air to water. Accordingly, systems transmitting and sensing an acoustic wave across different media face problems that increase costs and transmission losses impacting system reliability.

Therefore, in one embodiment, a system enhances sound transmission capabilities and power across different media using a plate that is perforated. The plate may be positioned at an interface for increasing transmission power at a resonant frequency associated with the plate. In one approach, the plate is a quadrangular shape having a circular hole at a center that receives the acoustic wave from a medium. Upon traveling through the circular hole, the acoustic wave propagates through a cavity to a different medium. The circular hole and the cavity allow the acoustic wave to propagate at a resonant frequency of the plate while maintaining a transmission power through decreasing reflections and refraction. In this way, the system implements a resonant structure that is simple for promoting sound transmission across different media through reducing transmission losses and distortions.

In one embodiment, a system that increases a transmission power of an acoustic wave traversing between an air and water interface through a plate that is perforated is disclosed. A system includes a plate having subplates that are positioned between a first medium and a second medium. The system also includes the plate that receives an acoustic wave that propagates from the first medium to the second medium, the acoustic wave associated with a wavelength. The system also includes the subplates being perforated with circular holes at centers, the subplates being a multiple of the wavelength, the subplates having a first depth and the acoustic wave propagates through the circular holes. The system also includes cavities of the subplates having a second depth that is less than the first depth. The system also includes the circular holes and the cavities propagating the acoustic wave at a resonant frequency of the plate, and a transmission frequency of the acoustic wave is associated with the resonant frequency.

In one embodiment, a waveguide that increases a transmission power of an acoustic wave traversing between an air and water interface through a plate that is perforated is disclosed. The waveguide includes a tube having a plate and the plate is positioned between a first medium and a second medium. The waveguide also includes the plate that receives an acoustic wave propagating from the first medium to the second medium, the acoustic wave propagates at a wavelength. The waveguide also includes the plate that is perforated with a circular hole at a center, the plate having a size that is a multiple of the wavelength, the plate having a first depth and the acoustic wave propagates through the circular hole. The waveguide also includes a cavity on a side of the plate with a second depth that is less than the first depth. The waveguide also includes the circular hole and the cavity that propagate the acoustic wave at a resonant frequency of the plate related to a transmission frequency of the acoustic wave.

In one embodiment, a system that increases a transmission power of an acoustic wave traversing between an air and water interface through a plate that is perforated is disclosed. The system includes a plate having subplates and the plate positioned at an interface between different media. The system also includes the plate that receives an acoustic wave propagating among the different media, the acoustic wave associated with a wavelength. The system also includes that the subplates are perforated with circular holes at centers, the subplates having a first depth and the acoustic wave propagates through the circular holes. The system also includes cavities on a side of the subplates with a second depth different than the first depth. The system also includes the circular holes and the cavities transmitting the acoustic wave at a transmission frequency of the acoustic wave and the transmission frequency is a resonant frequency associated with the plate.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B illustrate embodiments of a plate having a perforation positioned at an interface that receives and transmits an acoustic wave.

FIG. 2A-2D illustrate embodiments of the plate having an array of subplates that are perforated with circular holes and different structural dimensions.

FIG. 3 illustrates an example of a transmission power and a reflection power at a resonant frequency for a transmission using the plate.

FIGS. 4A-4C illustrate examples of dimensions associated with the plate impacting a resonant frequency and transmission of an acoustic wave.

### DETAILED DESCRIPTION

Systems and other embodiments associated with a plate increasing a transmission power of an acoustic wave traversing between an air and water medium where the plate is perforated are disclosed herein. In various implementations, systems transmitting and sensing an acoustic wave across different media have difficulties that increase costs, errors, and transmission losses. Therefore, in one embodiment, a system improves acoustic wave transmission across different media having various material densities using a plate including a circular hole that increases transmission energy and power. Here, the plate has a structure that matches the impedance between the different media for the acoustic wave during propagation. Furthermore, in another example, the plate has subplates having circular holes exhibiting various dimensions and cavities associated with the subplates. For instance, the cavities have a depth that is different than the depth of the subplates for adjusting transmission power and resonant frequencies. As such, the plate can be adaptable since the dimensions and depths impact the resonant frequency and transmission power for the acoustic plate. Accordingly, the system exhibits a resonant structure that is adaptable, reduces design complexities, and improves sound transmission between various media by minimizing transmission losses.

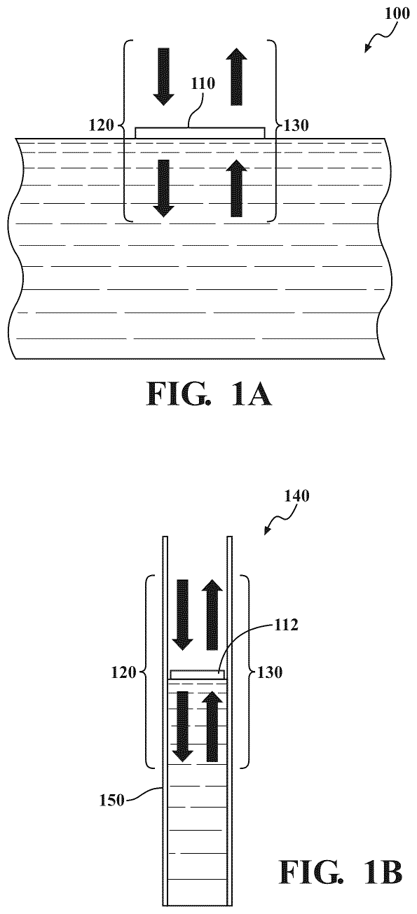

Now turning to FIGS. 1A and 1B, embodiments of a system 100 including a plate 110 having a perforation positioned at an interface are illustrated. Here, the plate 110 receives and transmits acoustic waves 120 and 130. The plate 110 can be one of a quadrangular shape, a square shape, and a rectangular shape. In other examples, the plate is one of a circular shape, a round shape, a curved shape, a ring shape, a disk shape, an elliptical shape, and an oval shape. Furthermore, a perforation may be one of a hole, a puncture, an opening, an aperture, a tear, a break, a gap, and a piercing. In the examples given herein, an acoustic wave can be one of a sound wave, a sound transmission, a sonic wave, a pressure wave, a vibrational wave, an audio wave, a mechanical wave, a longitudinal wave, etc.

FIG. 1A demonstrates that the acoustic wave 120 propagates from an air medium to a water medium through the plate 110 while maintaining a transmission power above a threshold through a perforation, such as a circular hole. For instance, the threshold is above 45%, 50%, 60%, etc. Similarly, the acoustic wave 130 propagates from a water medium to an air medium through the plate 110 while maintaining a transmission power above the threshold through the perforation. In one embodiment, the system 100 includes the plate 110 having subplates wherein the plate 110 is positioned at the interface between different media.

The plate 110 receives the acoustic wave 120 propagating among the different media and the acoustic wave 120 is associated with a wavelength. In another example, the subplates are perforated with circular holes at centers of the plate 110. Here, the subplates have a first depth and the acoustic wave 120 propagates through the circular holes. Furthermore, the subplates may have cavities on a side with a second depth. For instance, the second depth is less than the first depth. The circular holes and the cavities transmit the acoustic wave 120 at a resonant frequency of the plate that is a transmission frequency of the acoustic wave. As further explained below, this allows the system 100 a resonant structure that is straightforward for manufacturing and improves sound transmission across the different media through reducing transmission losses.

In FIG. 1A, an area of the plate 110 is smaller than the wavelength for increasing transmission power and energy as the acoustic wave 120 and the acoustic wave 130 traverse the interface. Furthermore, the cavities may be filled with air from a first medium to improve transmission power and quality. In another approach, a film applied to the cavities seals the interface between the different media to maintain transmission power and energy at a resonant frequency. The film can be one of a plastic, a silicon, and a foam material that has properties similar to a receiving medium (e.g., water), thereby avoiding an impact on transmission power and a resonant frequency. A bottom rim, edge, of a cavity can also have a material that gives the plate 110 buoyancy. In this way, the system 100 improves transmission of acoustic waves across an air-water interface by the plate 110 floating on water while the acoustic wave 120 propagates through the circular holes and the cavities.

Now discussing FIG. 1B, the waveguide 140 includes the plate 112 within a tube 150 that sets boundaries for the waveguide 140. Here, the tube 150 has the plate 112 positioned between a first medium (e.g., air) and a second medium (e.g., water). The tube 150 may be a pipe, a plastic tube, a plastic pipe, a metallic pipe, and a metallic tube. As further explained below, in one approach, the plate 112 comprises one of a single unit, at least two subplates, and a plurality of subplates. Furthermore, the plate 112 receives the acoustic wave 120 propagating from air to water at a wavelength. The plate 112 can be perforated with a circular hole at a center and exhibit a size that is a multiple of the wavelength associated with the acoustic wave 120. For instance, the multiple is one of a fraction and a proportion of the wavelength. In another example, the plate 112 is larger than the wavelength while the plate 110 is a subplate smaller than the wavelength. As explained below, the plate 112 has a first depth that impacts propagation characteristics as the acoustic wave 120 travels through the circular hole.

In various implementations, the plate 112 has a cavity on a side with a second depth that is less than the first depth. However, the depth size of the plate 112 and the cavity can be altered during manufacturing to achieve transmission at a particular frequency and power. The circular hole and the cavity structure allow and promote the acoustic wave 120 to propagate at a resonant frequency of the plate that is a transmission frequency of the acoustic wave 120. In this way, the waveguide 140 is adaptable when transmitting acoustic waves having different transmission frequencies.

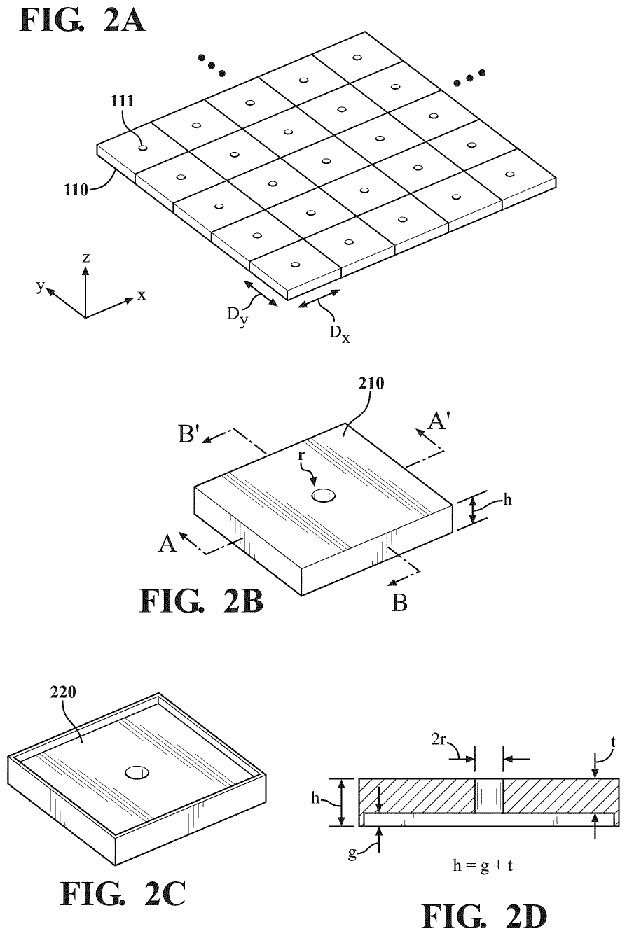

Regarding FIGS. 2A-2D, embodiments of the plate 110 having an array of subplates that are perforated with circular holes 111 and different structural dimensions are illustrated. In this example, a subplate 210 from the subplates is square with a width or length Dₓ. The height or length can be D_{y}. Furthermore, a center hole of the subplate 210 from the subplates has a radius r. This structure allows the plate 110 and the subplates to resonate for improving transmission of acoustic waves across media having different material densities.

In FIG. 2B, a cross-section view of the subplate 210. Here, the label A-A′ indicates the location and the direction of the sectional cuts A-A′ and B-B′ for a square shape. In other examples, the subplate 210 can be one of a quadrangular shape and a rectangular shape. In yet another approach, the subplate 210 is one of a circular shape, a round shape, a curved shape, a ring shape, a disk shape, an elliptical shape, and an oval shape. Furthermore, a perforation may be one a hole, a puncture, an opening, an aperture, a tear, a break, a gap, and a piercing. In the examples given herein, an acoustic wave can be one of a sound wave, a sound transmission, a sonic wave, a pressure wave, a vibrational wave, an audio wave, a mechanical wave, a longitudinal wave, etc.

Moreover, FIGS. 2C and 2D illustrate that the subplate 210 can have a height h and a gap height g for the cavity 220. For instance, the cavity 220 is air and the cavity 220 and the subplate 210 have similar shapes. In other configurations, the cavity 220 has a different shape than the subplate 210 for achieving different transmission characteristics with an acoustic wave. For example, the subplate 210 is a square while the cavity 220 is one of a circular shape, a round shape, a curved shape, a ring shape, a disk shape, an elliptical shape, and an oval shape. This allows implementations to alter and adapt transmission power and frequency characteristics to different acoustic waves, thereby improving system flexibility and robustness.

Regarding geometric details, a thickness h of the plate 110 and the subplate 210 is the first depth t added to the second depth associated with the gap height g. Here, the first depth t can be a hole length and depth derived by Equation(1):

h=g+t. Equation (1)

Equation(1) represents depth for the plate 110. In one approach, the space from the cavity depth adds capacity to a circular hole. This improves transmission power for the acoustic wave 120 and the acoustic wave 130 by improving resonance. In another example, an area size for the subplate 210 is smaller than a wavelength while thickness h is much smaller than wavelength for increasing resonance.

In yet another embodiment, the plate 110 an array of the subplate 210 positioned between a first medium and a second medium. Here, the plate 110 receives the acoustic wave 120 that is associated with a wavelength. The acoustic wave 120 propagates from the first medium to the second medium.

In another approach, the subplates are perforated with one of the circular holes 111 at centers and areas of the subplates are one of smaller or much smaller than the wavelength (e.g., a multiple, a fraction of a multiple, a proportion of the multiple, etc.). Furthermore, the subplates can have a first depth (e.g., the thickness h) and the acoustic wave 120 propagates through the circular holes 111. As previously explained, cavities of the subplates can exhibit a second depth (e.g., gap height g) that is less than the first depth. The circular holes 111 and the cavities propagate the acoustic wave 120 at a resonant frequency of the plate 110 associated with a transmission frequency of the acoustic wave. In another example, the transmission frequency is associated with the resonant frequency of the plate 110. In this way, the space from the cavity depth adds capacity to a circular hole for improving resonance that increases transmission power for the acoustic wave 120 and the acoustic wave 130.

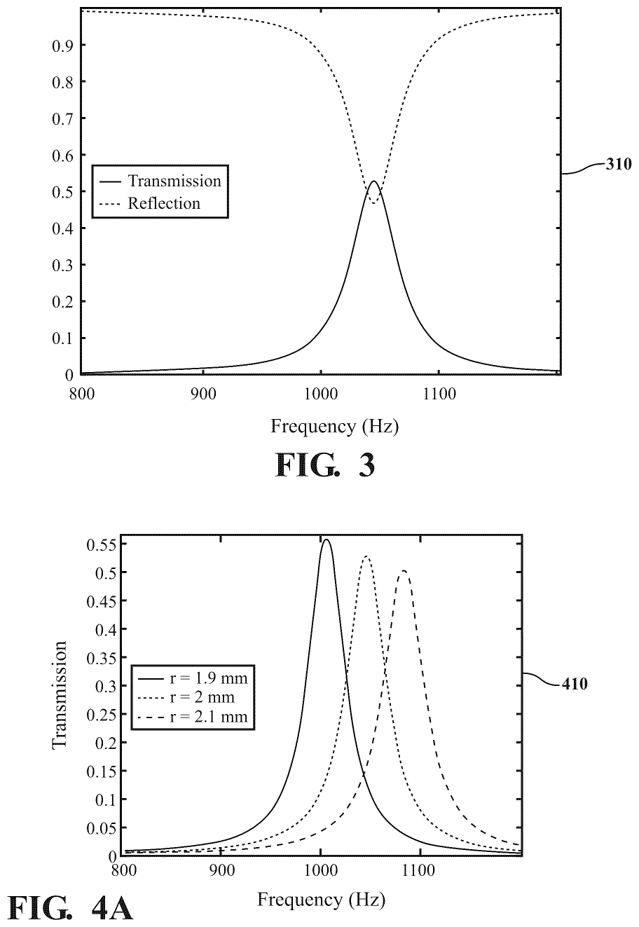

Regarding FIG. 3, an example of a transmission power and a reflection power at a resonant frequency for acoustic wave transmissions across the plate 110 is illustrated. Chart 310 illustrates results using g=2 millimeters (mm), t=5 mm, and r=2 mm. Although this example references millimeter dimensions, the plate 110 and the subplate 210 can adopt any dimensions that promote sound resonance and improve transmission power for acoustic waves traversing different media.

In chart 310, peak transmission power and energy appear at a resonance frequency of f₀=1050 Hz. In particular, peak transmissions exhibit transmission power greater than 50% at the resonance frequency while reflection power dips. Here, the transmission power can also be represented as a ratio between a transmitted power and a reflected power associated with an incoming wave and transmitted wave. Furthermore, the resonant frequency may reflect a preferred transmission frequency for the acoustic wave 120. Systems can manufacture the plate 110 with the appropriate dimensions to align resonant frequency and the transmission for the acoustic wave 120 As such, a transmitter can emit waves and a sensor can detect waves at the transmission frequency across different media using the plate 110.

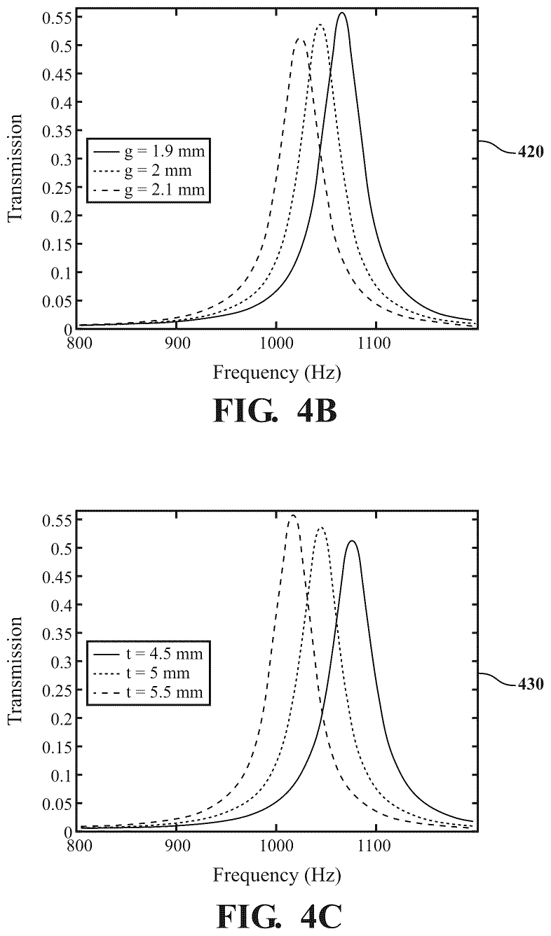

FIGS. 4A-4C illustrate examples of dimensions associated with the plate 110 impacting a resonant frequency and transmission of the acoustic wave 120. The size and length of a perforation can impact the resonant frequency of the plate 110. Chart 410 exhibits that a transmission power increases and a resonant frequency increases as radii, width, etc., of the perforation increases. In this example, the radii ranges from 1.9 mm to 2.1 mm, transmission powers ranges from 0.55 to 0.475, and resonant frequencies range from 980 Hz to 1100 Hz. Meanwhile, chart 420 shows a transmission power increases and a resonant frequency increases as the gap height g decreases. Here, the gap height g ranges from 1.9 mm to 2.1 mm, transmission powers ranges from 0.5 to 0.55, and resonant frequencies range from 1000 Hz to 1080 Hz.

Moreover, chart 430 exhibits a transmission power and peak decreasing for the acoustic wave 120 and a resonant frequency increasing as the first depth t decreases. Here, the first depth t ranges from 4.5 mm to 5.5 mm, transmission powers ranges from 0.55 to 0.5, and resonant frequencies range from 1000 Hz to 1080 Hz. Accordingly, the plate 110 has a resonant frequency that is tunable and an adjustable peak value for transmission power.

The plate 110 has many practical applications, such as systems including a level monitor and a communication system. In one approach, the plate 110 floats in a liquid within a vehicle tank (e.g., a gas tank). The acoustic wave 120 propagates through the vehicle tank and the liquid. The acoustic wave 120 encounters a bottom of the vehicle tank and causes a vibration. A reflected wave emits off the bottom of the vehicle tank.

Moreover, the reflected wave travels through one or more of the cavities and the circular holes 111, the reflected wave traveling from the second medium (e.g., water, liquid, etc.) to the first medium (e.g., air). Here, a sensor coupled to the plate 110 measures a power of the reflected wave and estimates a level of the liquid from the power. Furthermore, in another approach, the sensor has a sound emitter transmitting the acoustic wave 120 from an air medium and measures transmission of a reflection back from a bottom of the vehicle tank using a receiver. Similarly, the sensor can monitor a void inside a gas based on travel time between either side of the plate 110.

Another application involves a communication system having a communicator outside of a water medium in an air medium and a vehicle underwater. For example, the communicator transmits the acoustic wave 120 having data that is modulated. The plate 110 floats on water and a vehicle within the water receives the acoustic wave 120 and demodulates the acoustic wave 120 to derive the data. Accordingly, the plate 110 has a resonant structure that expands applications and exhibits a simple and adaptable form that improves sound transmission between various media by minimizing transmission losses at various transmission frequencies.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a plate having subplates and positioned between a first medium and a second medium;
the plate receives an acoustic wave that propagates from the first medium to the second medium, the acoustic wave is associated with a wavelength;
the subplates are perforated with circular holes at centers, the subplates being a multiple of the wavelength, the subplates having a first depth and the acoustic wave propagates through the circular holes;
cavities of the subplates having a second depth that is less than the first depth; and
the circular holes and the cavities propagate the acoustic wave at a resonant frequency of the plate, and a transmission frequency of the acoustic wave is associated with the resonant frequency.

2. The system of claim 1, wherein:
upon an increase of radii for the circular holes, a transmission power of the acoustic wave between the first medium and the second medium increases and the resonant frequency increases;
upon a decrease of the second depth, the transmission power between the first medium and the second medium increases and the resonant frequency increases; and
upon a decrease of the first depth, the transmission power between the first medium and the second medium decreases and the resonant frequency increases.

3. The system of claim 1 further comprising:
the plate floating in a liquid within a vehicle tank;
the acoustic wave propagating through the vehicle tank and a reflected wave from the acoustic wave emitting off a bottom of the vehicle tank;
the reflected wave traveling through the cavities and the circular holes, the reflected wave traveling from the second medium to the first medium;
a sensor coupled to the plate that measures a power of the reflected wave; and
the sensor estimates a level of the liquid from the power.

4. The system of claim 3 further comprising:
a film seals the cavities from the liquid and the cavities are filled with air associated with the first medium.

5. The system of claim 1, wherein a thickness of the plate is the first depth added to the second depth.

6. The system of claim 1, wherein the first medium and the second medium are one of air and water.

7. The system of claim 1, wherein:
the acoustic wave maintains a transmission power above a threshold through the circular holes; and
the multiple is one of a fraction and a proportion of the wavelength.

8. The system of claim 1, wherein the subplates have one of a square shape, a rectangular shape, and a circular shape.

9. A waveguide comprising:
a tube having a plate;
the plate is positioned between a first medium and a second medium;
the plate receives an acoustic wave propagating from the first medium to the second medium, the acoustic wave propagates at a wavelength;
the plate is perforated with a circular hole at a center, the plate having a size that is a multiple of the wavelength, the plate having a first depth and the acoustic wave propagates through the circular hole;
a cavity on a side of the plate with a second depth that is less than the first depth; and
the circular hole and the cavity propagate the acoustic wave at a resonant frequency of the plate related to a transmission frequency of the acoustic wave.

10. The waveguide of claim 9 further comprising:
a film seals the cavity from the second medium and the cavity is filled with air associated with the first medium.

11. The waveguide of claim 9, wherein a thickness of the plate is the first depth added to the second depth.

12. The waveguide of claim 9, wherein the first medium and the second medium are one of air and water.

13. The waveguide of claim 9, wherein:
the acoustic wave maintains a transmission power above a threshold through the circular hole; and
the multiple is one of a fraction and a proportion of the wavelength.

14. The waveguide of claim 9, wherein the plate has one of a square shape, a rectangular shape, and a circular shape.

15. A system comprising:
a plate having subplates and the plate positioned at an interface between different media;
the plate receives an acoustic wave propagating among the different media, the acoustic wave associated with a wavelength;
the subplates are perforated with circular holes at centers, the subplates having a first depth and the acoustic wave propagates through the circular holes;
cavities on a side of the subplates with a second depth different than the first depth; and
the circular holes and the cavities transmit the acoustic wave at a transmission frequency of the acoustic wave and the transmission frequency is a resonant frequency associated with the plate.

16. The system of claim 15 further comprising:
a communicator of a communication system transmits the acoustic wave having data that is modulated;
the plate floating on water; and
a vehicle within the water receives the acoustic wave and demodulates the acoustic wave to derive the data.

17. The system of claim 15 further comprising:
a film seals the cavities and the cavities are filled with air.

18. The system of claim 15, wherein a thickness of the plate is the first depth added to the second depth.

19. The system of claim 15, wherein the acoustic wave maintains a transmission power above a threshold through the circular holes.

20. The system of claim 15, wherein the subplates have one of a square shape, a rectangular shape, and a circular shape.
